(19) United States
(12) Patent Application Publication
(10) Pub. No.: US 2004/0221118 A1
(43) Pub. Date: Nov. 4, 2004

(54) Control of access to data content for read and/or write operations

(76) Inventors: Alastair Michael Slater, Wilts (GB); Mark Robert Watkins, Bristol (GB); Andrew Michael Sparkes, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/766,032

(22) Filed: Jan. 29, 2004

(30) Foreign Application Priority Data
Jan. 29, 2003 (GB) 0301987.4

(51) Int. Cl. G06F 12/14

(52) U.S. Cl. 711/163

(57) ABSTRACT

A data storage device has a non-volatile memory-storing data content, and a control processor for evaluating selected data content of the memory to establish whether there is a match between a characteristic of, or a derivative of, the data content and a reference data content characteristic, or derivative. The processor takes an action in response to the match.

### FIELD OF THE INVENTION

The invention relates to the storage of data and the control of access to data in storage devices that are computer-accessible.

### BACKGROUND OF THE INVENTION

There is a lot of data content easily available to computer systems where there are rights in the data content. For example, music, video, photographs, and other artistic or performance works all enjoy copyright, but are all easily available in computer-readable form. Downloading files from the Internet is easy. Copying CDs or DVDs to electronic computer memory, or to removable data carriers such as other discs or DVDs, is easy, or systems to inhibit that may be easily circumvented. There is a great deal of computer/digital piracy of the copyright rights of the creators of artistic works such as music, video, and pictures. Furthermore, whilst not commercial scale piracy, there are also a great many private individuals making unauthorised copies of works in which other people have rights. This may typically be copying music from a network, such as the Internet (e.g. Peer-to-Peer-type file sharing), or copying CDs or tapes of music, often now copied into electronic computer accessible memory (e.g. as MP3), or copying videos from tape or CD onto computer memory. Furthermore, it is very often not necessary for a private individual to gain access to the original media in which the rights-protected work was released: often the content of the artistic work has already been stored in computer memory somewhere and individuals can copy it off other computer-stored data content. For example they maybe able to copy it off the Internet.

A further problem is that responsible organisations, for example businesses, can have their computer equipment misused by staff for the illegal copying and storage of rights-protected works.

Copyright is not the only way that works can enjoy legal protection: another example is that some countries have database rights in the information content of a database.

Peer-to-Peer type file sharing over computer networks makes it difficult for a rights owner, or original data content provider, to control, or even know about, the dissemination and storage of copies of their works.

The above issues have been considered for years. Attempts to control the ability of people to copy works have been made. However, customers do not really like special formatting of works, or needing to use special devices, so that customers cannot transfer a copy of a work that they have bought to another of their media-playing devices: they want to be able to copy what they have bought, and to use it on older equipment. For example, they want to be able to buy an original CD and copy it onto tape, or to MP3, for use with other music playing devices that they may own. However, giving customers that ability probably means that other people can copy and access the work further, without the knowledge of the original work provider, and without further payment. This is an awkward dilemma.

### SUMMARY OF THE INVENTION

According to a first aspect the invention there is provided a method of operating a network attached storage device, the method comprising upon receipt of a request to store content, attempting to identify the content to be stored, and following a set of rules to be followed if the data content is identified or is not identified as being known, and undertaking appropriate action responsive to the identification of the identity of said data content to be stored in accordance with said set of rules.

In some known operating systems there is the concept of files having permissions that are user/group/other. If you are the user who created a file you can do certain things. If you are in the same group as the user who created the file you can do certain things. If you are someone else you can do certain allowable things. The certain things that the prior art allows are read/write/execute. There are ways in the prior art Unix operating system of putting users into groups and setting file permissions that give some control over what users can do. However, the prior art does not assess the actual content of the data content. There is no concept in the prior art of content-based segmentation of what can be done by users.

Furthermore, the prior art does not have any temporary based nature of permissions granted. Segmenting allowable capabilities of users by file headers, or user identity, without the actual data content being instrumental in determining the ability of who can do what, is different from the present invention.

In embodiments of the present invention the content may comprise a data content entity, such as a file or a database.

A specific identity of a data content entity may be identified, for example the data content entity may comprise a video performance and the identity of the video performance may be identified. The method may comprise identification of a group or class of data content to which a particular data content belongs, for example it may comprise establishing that the data content of said data content entity is a video, and not a still picture or music alone. Of course, the method may comprise identifying a unique single data content entry from a determination of at least some of the data content.

Preferably the data content entity comprises a file. The data content entity may comprise streamable content, possibly rich media content (by rich media is meant not just plain text: e.g. music, video, multimedia, etc.). Said storage device may comprise a file server. Alternatively said data content entity may comprise a database, rather than a file.

Identifying the content of the data content entity relates to an evaluation of an attribute of the content itself, rather than evaluating the delivery mechanism of the content, or the file type.

Preferably an attempt to identify the content of a data content entity comprises producing a signature or fingerprint using said data content and comparing said produced signature or fingerprint with reference signatures or fingerprints relating to data content whose identity is already known.

It will be appreciated that although a “signature” or “fingerprint” may be an artefact produced by processing a specific data content, it need not necessarily be so. It is something which is derivable from the data content and is identifiable as being linked with the data content, possibly in a unique one-to-one relationship, or at least it is unlikely that another different data content will have the same pattern/signal. It could simply be an extract of said data content, unprocessed (e.g. a short extract).

Said identity may be a unique identity for said data content, or it may comprise a category or kind or type of data content.

A network-attached, or attachable, storage device (NASD) is one designed to attach to a computer network specifically to deliver content to the network and is not a general purpose computing device such as a PC: it is an appliance-type device. A NASD typically has a processor and computer accessible memory, with its processor running the same software all of the time, or nearly all of the time, (because the appliance/device has only one function—to deliver content/store content—or at least that is its overwhelming main function). In a PC, or other general purpose computing device, the processor typically has access to many different software programs that are selectable by the user of the PC, and which software is running varies with time under the immediate and direct control of the user. A NASD, such as a file server, typically has no display unit, no keyboard, no mouse, no user operable software-selection and little or no user-interaction control. A NASD attaches to a network and is typically, for example in the case of file servers, has accessible files. By dedicating the processor of a NASD to file-serving tasks better file serving task performance is achievable using the same computing power than can be achieved by using a general purpose computer to serve out files as one of its many (e.g. tens) of possible functions. A skilled man will be able to distinguish between a. NASD and a general purpose computer, such as a PC.

It is known to have a firewall in a network pass or block requests to access files on the network by assessing a file extension, or the file address, to be accessed. This is not an evaluation of the content of the file; just its packaging. It is possible to get the same content past the firewall by re-packaging it and/or seeking to obtain it from an allowable address. Such firewall screening systems are not content-aware, just address and/or packaging aware. Furthermore, firewalls in networks are not running on individual NAS devices: they are on a systems access-to-outside-world processor. Typically, firewalls are part of the networking infrastructure of either a company owning user computers or of an internet access provider/content hosting entity.

Said appropriate action that said network attachable data storage device is configured to take upon identifying data content may comprise storing said content. Said appropriate action may comprise not storing said content. Said appropriate action may comprise communicating with a third party. Said appropriate action may comprise informing a third party that said data content has been stored, or that an attempt to store it was made.

There may be an interaction between a party external to the device (for example a third party) that is not a data content accessing party accessing data content and the device.

The interaction may comprise the external party providing information into said device and/or receiving information from said device.

Third party interaction: whether that be the providing data into said NASD, or receiving information from said NASD, is a feature of many embodiments of the invention, but it is not essential to all embodiments. Third party mediated control of the response of the NASD to user requests to store and/or access data content entities is a feature of many, but not all, embodiments.

As well as, or in addition to, an interaction with a third party (which could comprise a user of the NASD), which comprises a communication from the NASD to said third party, there may be a communication from said third party (or another, further, party) to said NASD. For example a third party may communicate a data content entity signature to said NASD, or information which interacts with said rules to assist in controlling what is said appropriate action. For example, a price, or a time, may be communicated to said NASD from a third party, who may not be the party storing said data content entity or the party accessing said data content entity.

The data storage device may be able to ascertain the identity of an accessing party or computer device which made the request to store the data content. That identity may be provided to an external, or third, party and/or information derived from that identity. For example a group or class of user-identity, but not necessarily a specific user identity, may be conveyed to an external party.

Said appropriate action may comprise generating or augmenting an account related to the user identity and/or the identity of said storage device. Said account may comprise a financial account for request for payment and/or it may comprise an information account for analysis, for example by an interested party.

The method may be performed on a device which has content-usage control parameters corresponding to and associated with each identified content, the method comprising using said content-usage parameter in determining what appropriate action is undertaken. The content-image control parameters may be held on the device, or off-device.

The content-usage parameter may be inputable to said device or updateable in said device by a third party. The third party may input a price to be charged associated with said content, a price to be charged to said device or an owner of said device and/or a price to be charged to a party requesting storage of said content, or to an entity associated with the requesting party (e.g. their employer). Alternatively or additionally the third party may input a limitation upon the use of said content, for example the number of times it can be accessed, and/or the identity of who can access it, and/or a time frame over which the content may be accessed, and/or a sharing parameter adapted to influence an ability to share accessed content with other machines.

The content usage parameter may be held in a parameter memory, e.g. a database, of the NASD, or the NASD may call it down when it needs it—for example from a computer of a content rights provider or manager. For example a content rights provider could keep a database of prices for different works and the NASD could look up the price on the content-provider's computer upon use of the work by a user.

In one preferred embodiment a content originator, or content rights owner, (or their proxy) inputs and/or updates content-usage parameters, for example the cost to the device owner (if any) for storing an identified content belonging to said rights owner, and/or the cost to the person requesting said content to be stored, and/or the cost to an accessor party who accesses said content held upon said storage device and/or a sharing parameter.

Said appropriate action may comprise communicating with a party external to said storage device. It may comprise providing information to a third party external to the device that is not the person requesting content to be stored. It may comprise issuing a request for payment to someone (who may be the person requesting that data content be stored, or the person requesting access to the stored data content, or the person owning the NASD and/or network). It may comprise providing content-storage related information to a rights owner who is recorded on said storage device as owning rights in content that has been identified, or to a different third party (possibly a competitor, or marketing-related organisation).

According to a second aspect the invention there is provided a data storage device having a non-volatile memory for storing data content, and a control processor, operable to evaluate selected said data content to establish whether there is a match between a characteristic of, or a derivative of, said selected data content and a reference data content characteristic, or derivative, and to take an action in response to establishment of a said match.

Preferably said selected content is from the group: content that has been sent to the data storage device for storage there, for example newly received content; or content already stored on the storage device.

The action may include sending information relating to an interaction between an accessing party and content accessed by said accessing party, said processor being adapted to send information to a party that is not said accessing party.

The control processor may be operable to sweep data content stored in its memory, possibly periodically, possibly upon receipt of a trigger, in order to evaluate said content, or at least new said content updated since a previous sweep. The control processor may be operable to perform an evaluation of content putatively to be added to the memory of the data storage device prior to said content being added to said memory. Said device may have a content evaluating memory, or a buffer, for storing newly received content prior to and/or whilst newly received content is evaluated.

The device may comprise a library of data content characteristics or derivatives. Said characteristics may comprise an identity characteristic to identify said data content as being known, for example as being a known work (such as music or video). The identity characteristic may comprise a signature derived from said data content or a fingerprint derived from said data content.

Signature, or fingerprint, recognition is a known field, typically involving applying an algorithm to a signal, or data content, to derive a much shorter signature or fingerprint data set which is extremely unlikely to be repeated by application of the algorithm to other, different, data contents. Comparing signatures or fingerprints for matches is far less computationally intensive than comparing whole, unprocessed, data content entities.

An alternative signature or fingerprint regime could be to take just a section or sample of the data content to compare/use as an identifier. Whilst the extracted sample is unprocessed, there is still processing of the whole data content entity in order to extract the sample.

A fingerprint may be considered to be, in some embodiments, a short sample of actual data content, for example, at a given, set, rate of encoding. For example, a few seconds of an audio track (e.g. of music or a video), possibly the first few seconds, or a sample relatively near the start of the track.

A signature may be considered to be, in some embodiments, an algorithmically derived value or pattern derived by running a sample or the whole, or substantially the whole, datum through a signature-creation algorithm.

It is desired to protect the use of both approaches, and indeed other approaches, of identifying content.

For fingerprints it may be necessary to match multiple differing encoding rates. For signatures there may be different signatures for the same data, derived from different sorts of input of basically the same data (e.g. different input bit rates for audio data or different picture sizes for visual data). The same data may, for example, have different signatures if a signature algorithm samples a datastream of said data periodically and takes a set number of bits of data at the sampling points in the datastream. If the bit rate for the datastream is different, the signature will be different. A single data content may have more than one signature and/or more than one fingerprint. Preferably a single fingerprint or signature points to a single data content.

An appropriate content-identification regime can be chosen by a content provider once they know the nature of their content. If a content provider provides, for example, immutable content, such as a training slideset, then an appropriate percentage of the same textual content may be used to identify the data content.

Said device may comprise a data content-related parameter correlation, said correlation linking content-related parameters with equivalent known data content characteristics or derivatives. Said processor may be adapted to use said parameters in determining what said consequential action is to be.

Said parameters may be controllable by a third party, possibly by inputting parameter control signals to said processor, possibly remotely, for example over a telecommunications port of said device.

The processor may be configured to enable third party mediated control of what is to be said predetermined action. Having content-related parameters and allowing third party control of said parameters, and using said parameters in determining what said consequential action is to be, is one way of providing said third party mediated control.

Said consequential action may be predetermined in the sense that once the parameters are set the consequential action is determinable, and is predictable.

According to a third aspect of the invention there is provided a network attachable file server having:

a computer memory for storing files;

a file content monitor processor;

a reference library of file content-related signatures and content-related attributes correlated with said signatures;

said processor being operable to evaluate content of a file to determine a content related attribute of the file and to take a an action responsive to the evaluation of the content related attribute of the file;

the evaluation including obtaining a signature or fingerprint of said file and comparing said obtained signature or fingerprint with stored signatures or fingerprint of said reference library in order to establish a match, thereby establishing a correlated content-related attribute of said file, said processor being adapted to take said predetermined action dependent upon what content-related attribute of said file has been established.

Evaluating signatures of files is better than evaluating file headers, or file extensions, or file delivery packaging, because it is harder to disguise the actual data content of a file than to hide the type of data content by altering packaging.

The content-related attribute may comprise a unique file identity, or the identity of a class or kind of data content of the file.

The predetermined action is in many embodiments the communication with an external party, external to said NASD. Said external party may be a user requesting the storage of a file and/or requesting access to a stored file. Said external party may comprise a third party that is not the person requesting storage of, or access to, a file. Said consequential predetermined action may be the generation of an information or financial account for transmission to an external party and/or may comprise the actual transmission of said account.

There are times, for example when a private individual accesses data content, when it is desirable to attribute a cost, or generate an invoice, directly to the accessing user/party. There are other times, for example if a user, user A, accesses training materials provided by their employer, company B, when it may be desirable to attribute a cost to, or invoice, an entity that is not the entity that accessed/used the data content (e.g. the invoice/cost may be allocated to the employing company B, instead). The actual accessing party to whom data content is delivered, or who stores data content, may be acting on behalf of another entity, or under their responsibility, and the “other entity” may be communicated with. For example, a supervisor of a group of employees may automatically receive a notice from the NASD when one of their employees accesses a training module on the NASD. This may enable the supervisor to be informed of the progress of training, for example.

Said predetermined action may be established by said processor with reference to programmed rules which refer to a set of parameters relating to said stored signatures. Said parameters may be variable, possibly remotely variable, by a third party. Said parameters may comprise respective costs for storage of and/or access to respective files. Said programmed rules may be adapted to set the cost of access to and for storage of files and/or vary the cost of access to and/or storage of specific files over time. Said programmed rules may be adapted to set and/or vary a usage parameter for each or specific files. Said usage parameter may be a time gate in which said files may be stored and/or accessed. Said usage parameter may be a number of times a stored file may be accessed, for example accessed by a given consumer or group of consumers. Said usage parameters may be user-identity related. There may be different parameter settings for different users: i.e. the same parameter may have different settings for use with different users. A user may be a party requesting access to a data content entity, or an entity requesting to store a data content entity.

The files may comprise rich media, for example music, video, or multimedia.

According to another aspect the invention comprises a network having at least one NASD, said NASD being in accordance with the second aspect of the invention and/or said network being operable in accordance with the first aspect of the invention.

The network may have a plurality of NASDs.

According to another aspect of the invention there is provided a method of integrating storage of data files having a data content with management of rights associated with said data files, using a network attached file server which is capable of accessing said data content of a file and which is capable of producing a report relating to storage and/or access of files having associated rights, the method comprising using said file server to assess files stored on it, or files to be stored on it, to see if an attribute related to the content of accessed files, can be established by screening said content against known attributes, thus establishing said content as belonging to a known file or class of files, and using the results of the assessment to produce said report, and transmitting said report externally of said file server.

The report may comprise billing information, or indeed be an invoice. The report may comprise access and/or storage-related data, linking access and/or storage activity with a known file or class of file. The report may be issued to a rights' owner or their proxy. The rights owner may be the owner of copyright in the data file that has been accessed.

According to another aspect of the invention there is provided software, possibly encoded on a machine readable data carrier, which when run on a processor of a computer memory network attached storage device having a processor, a non-volatile memory, and a library of signatures, is adapted to cause said device to evaluate data content of a data content entity either stored in said memory or received by said device for storage in said memory and to create a signature or fingerprint derived from said data content and capable of identifying said data content;

and to compare said created signature or fingerprint with reference signatures or fingerprints held in said library of signatures or fingerprints so as to establish whether said created signature matches a reference signature and thereby establish an identity of said data content;

and perform a predetermined act which is influenced by said identity of said data content.

The predetermined act may include communicating externally of said device information that is related to said identity of said data content.

The communicating externally of said device may comprise communicating with a party that is not a user party requesting access to a data content entity or requesting to store a data content entity.

Said software may refer to a set of content-related parameters in determining what is to be said predetermined act. Said software may permit said parameters to be input or changed by input of parameter-controlling signals sent to said device, preferably telecommunications signals. A third party may be able to set said parameters remotely.

Said software may be adapted to cause said processor to permit one set of parameters to be associated with a group of data content entities controlled by a party external to the device, and a different set, or different sets, of parameter(s) controllable by a different party external to the device, or further external parties. For example, a plurality of rights owners, each owning rights in their own data content entities, may be able to set parameters used in conjunction with their own data content entities, but not another's. Additionally or alternatively the software may be adapted to cause said processor to permit a specific data content entity to have a plurality of parameters related to it, and to permit different parties to set different parameters of the same data content entity.

The software may allow third party mediated control of the response of the NASD to user requests to store or access data content entities.

According to another aspect of the invention there is provided a method of controlling access to a memory of a data storage unit using a knowledge of content of data content entities stored in, or to be stored in, said memory and “a knowledge of” a user identity, and proceeding to take an act dependent upon said knowledge of the content and the identity of the user, said act being causally connected with a communication to a third party that is not the user.

Said other act may be one or more of:

denying a user the ability to store a prohibited file in said memory, and preferably reporting an attempt to store a prohibited file to a third party;

allowing the information to be stored and then reporting on the user to a third person;

generating/updating a bill/account for the user or further party, which is instrumental to eventually generating a bill/cost for the user or a further party gathering commercial demographic information on file usage (e.g. who is accessing what, when, how often, for how long);

communicating data content-access history related demographic information to a third party (e.g. either the rights owner, their competitor, or a billing function, or the user's supervisor/manager).

It will be appreciated that demographic information relating to information about which demographic groups are accessing what data content, or what classes of data content, can be valuable information. A third party may be required to agree to pay for such information before it is communicated to them: the information may be a vendible product in its own right.

Also, it may be possible for a data content rights owner (e.g. copyright owner, or database right owner), or a data content provider (e.g. NASD owner), or a user (e.g. home or business consumer) to pay to, or request to, have transactions relating to thein not taken into account in the gathering of this demographic information; or alternatively to pay to, or request to, have their transactions taken into account. The actual identity of a user/content provider/data content/rights owner may be released as part of the demographic information or it may be masked/not released. A party may opt in, or out, of releasing identifying details of themselves, possibly with a payment being required.

Possibly reporting to geographically remote third parties might be interesting, for example reporting to different commercial organisations.

There may be a greater granularity in the decisions that can be made regarding access to files—for example an access decision (to store or read a file) may not simply be yes/no, there could also be differential pricing which could vary with user I.D., time, number of previous related requests, etc. Alternatively, conditional or limited access may be permitted, for example access may be granted, but only so many times, or only within a selected time gated window—more beyond just a straight yes/no. This could also be applied to cover storage as well—storage at differential prices/outcomes. This differs from existing access control and user authentication mechanisms, such as directory services or domain controllers. The latter are coarse grained access control mechanisms which correlate user access with filenames, not data content itself. Embodiments of the present invention may use filename-user pairing as a control mechanism, as well as data content-derived control.

According to another aspect of invention there is provided a network attached storage device having a memory and having details of files accessible through said device, details of users entitled to access the NAS device for read and/or write operations, and a set of rules specifying actions to be taken upon receipt of a request from allowable users to access files; wherein said rules are dependent upon the identity of the user and/or content of the file concerned;

and a network link to enable the device to be connected to a third party on the network;

and a processor as part of said device configured to monitor access by users to files and to communicate with a network attached third party data that is user and/or file dependent and representative of the user-data content access activity.

According to another aspect of the invention there is provided a method of providing read and/or write access to a data record entity stored in a computer readable memory of a network attachable data storage device having stored therein or accessible thereto information correlating a plurality of data record entities stored in said memory and content-related characteristics adapted to identify an equivalent said data record entity; and access authority parameters associated with said record entities or said content-related characteristics; wherein the method comprises accompanying requests to read and/or write access to data content entities are by a user access authority indicia, there being a relationship between user access authorities and access authority parameters to enable a user to access data record entities for which the user has authority to read and/or write access, the network attachable storage device evaluating a user's access authority indicia and an access authority parameter of a requesting data content entity in order to determine whether access is granted or not.

According to another aspect of the invention there is provided a method of integrated storage of rights-controlled data content entities and billing for storage and/or use of said rights-controlled data content entities, said method comprising using a network attached storage device to evaluate requests for storage and/or read requests for access to memory of said device, and to compare identities of users making said requests with content-related indicators in order to determine whether said request is allowed, and generating billing relating to user access request activity based upon user identity and content identity.

According to another aspect of the invention there is provided a computer accessible data storage device having a data storage means, and processing means,

said processing means comprising reference data content characteristic means having or being adapted to obtain reference data content characteristics representative of known data content, and content identifying means adapted to evaluate a selected data content against said reference characteristics from said reference characteristic means in order to establish whether a characteristic of said selected data content matches a said known data content characteristic;

and wherein said processing means is programmed to take a consequential action pursuant to said content identifying means establishing that a characteristic of said selected data content matches a known characteristic.

### BRIEF DESCRIPTION OF THE DRAWINGS

Some embodiments of the invention will now be described by way of example only with reference to the accompanying drawings, of which:

FIG. 1A shows schematically a network attached storage device (NASD) in accordance with one embodiment of the invention;

FIG. 1B shows schematically a data content entity stored in memory of the device of FIG. 1A;

FIG. 1C shows schematically some characteristics of data content of the data content entity of FIG. 1B;

FIG. 1D shows a signature or fingerprint derived from the data content of FIG. 1C;

FIG. 2 shows schematically a part of a network having a NASD in accordance with another embodiment of the invention;

FIG. 3A shows another NASD and network including the NASD;

FIG. 3B shows schematically a content-related parameter database associated with the NASD of FIG. 3A;

FIG. 4 shows the NASD of FIG. 3A as part of another network;

FIG. 5 shows the NASD of FIG. 3A as part of another network;

FIG. 6A shows schematically a database of file identifications with associated content-dependent parameters;

FIG. 6B shows schematically a database of user identifications with associated user-related parameters;

FIG. 7 is a schematic flowchart illustrating a process for requesting the storage of content upon a computer memory in one embodiment of a NASD;

FIG. 8 is a schematic flowchart showing a request to access a file on a NASD; and

FIG. 9 is a schematic representation of an embodiment of the invention in which a NASD has input to it by an external rights provider parameters which influence how requests to read and/or write data content are handled.

### BRIEF DESCRIPTION OF SOME EMBODIMENTS OF THE INVENTION

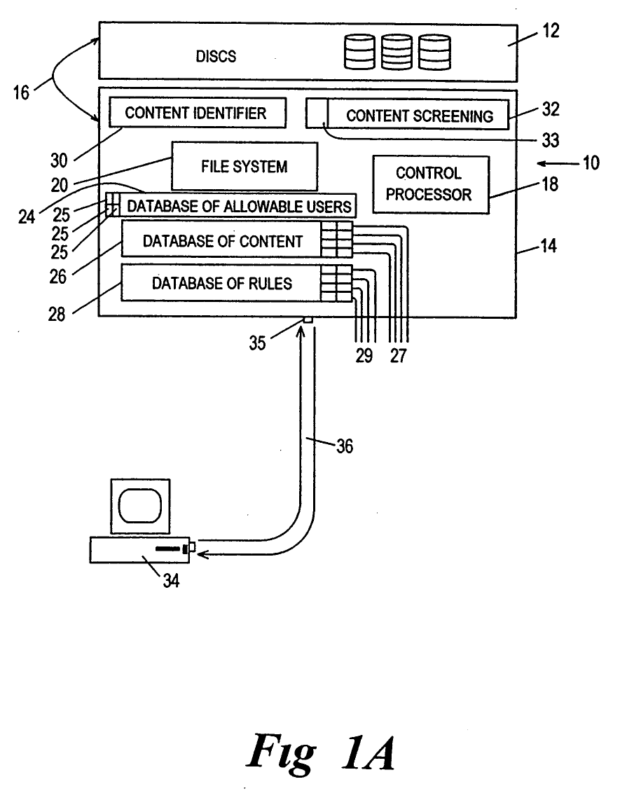

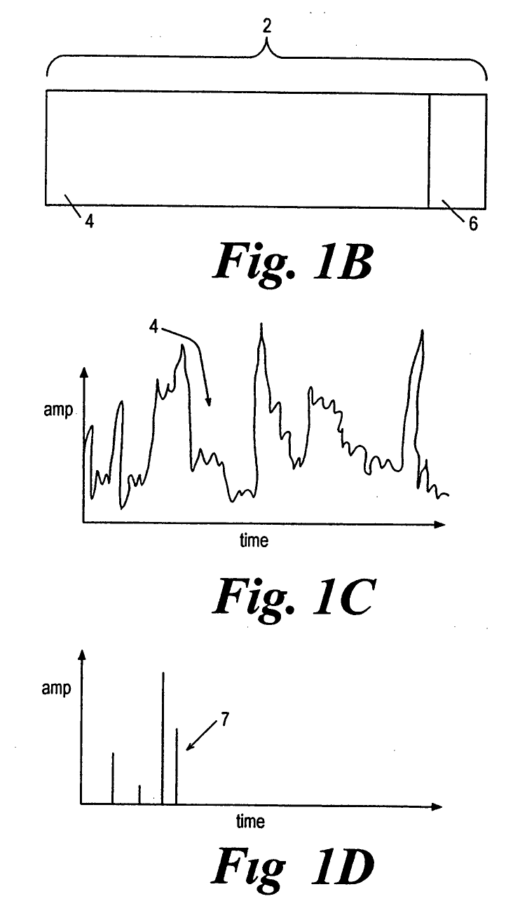

FIG. 1A to 1C show a computer accessible network attached storage device (NASD) 10 having a machine readable computer memory 12 in the form of magnetic discs, and a memory access controller 14 linked to the memory 12 by a communications link 16 in the form of a SCSI or Fibre Channel link. The memory 12 stores data content entities 2 (FIG. 1B), in the form of files, having a data content 4 that is the information content of the entity, and associated packaging 6, such as a file extension which is not the data content itself but is needed in the delivery mechanism and/or file system of the computer system. The controller 14 has a control processor 18; a file system 20 which manages the allocation of files in the memory 12 and which identifies the location of files in the memory 12; a database 24 of allowable users 25; a database 26 of known content-identifiers, indicia, or signatures 27; a database 28 of rules 29; a content identifier 30; a content screener 32; and a buffer memory 33 associated with the content screener 32.

The components of 12 to 30 of NASD 10 are housed in a housing (not shown). There may be disc storage external of the housing in addition to the external discs 12. In another embodiment there are no discs 12 within the NASD housings: they are external of it.

A user 34, in this case in the form of a personal computer, is connected to a telecommunications port 35 of the NASD 10 via a network 36.

File serving from the NASD to the user 34 typically takes place over protocols such as NFS (for Unix systems) and CIFS (for Windows). In use, the NASD 10 receives a request from user 34 via port 35 to store a particular file, or data content entity. The incoming file is held in buffer memory 33 whilst it is evaluated to see if it is permitted to store that file on the NASD. The content identifier 30 operates on the new file to see if an identifier can be established for the file. In this example, the content identifier 30 operates on the file in the buffer 33 with a processing algorithm (not shown) to produce a signature, or fingerprint, representative of that file. In this case the identifier/signature is representative of a unique identity of the file. In other examples, it could be representative of the class, category, or kind of file (e.g. music, video, or movie performance, or name of band, or significant actor in movie, pornographic content (e.g. to bar it), sport content, protected content, to name but a few possible classes). FIG. 1C shows schematically the data content 4 of file 2 and FIG. 1D shows an identifier signature 7 derived from the data content 4. The identifier is shorter, simpler, and easier to compare with other identifiers. In the example of FIG. 1c the data content is audio, for example the audio track of a video, but it need not be. The Figure is only a visual representation of a varying signal, which need not be audio. It could be colour intensity with position or time, or concentration of identified structures with spatial position, or identifying a marker or identifier deliberately introduced (e.g. a code).

The control processor also takes the packaging 6 and establishes the address from which the file 2 came and checks in the database of allowable users the identity of the user, and that they are allowed to use the NASD at all, and for the purpose of storing files (i.e. not just read only authorisation).

The control processor 18 causes the content screener 32 to check the identifier 7 for the file held in buffer memory 33 against the content identifiers 27 of the database of content 26. The database of content 26 in this example contains equivalent identifiers 27 for prohibited files that are not to be allowed onto the NASD, as well as identifiers for those files that are already stored in the memory 12.

The control processor 18 refers to the database of rules 28 to establish what to do. The rules 29 in this example dictate that if no match is found in the database of content 26 the newly-transferred file held in buffer memory 33 is transferred to the main memory 12 under the control of the file system 20, which puts the file in memory 12 and adds the address for that new file into the filesystem 20.

If the content screener establishes that the content identifier 7 matches a known content identifier representative of prohibited content the rules say that the processor 18 refuses to store the content in the memory 12. In one embodiment the rules cause the processor 18 to send the content back to the user 34, possibly with an indication that the content is prohibited. In another embodiment the processor 18 simply does not store the data content, and replaces it with a “prohibited” notice. This may allow the user who tries to store prohibited content still to be charged for storing something—but not actually storing the objectionable content. In another embodiment nothing is stored in the memory 12.

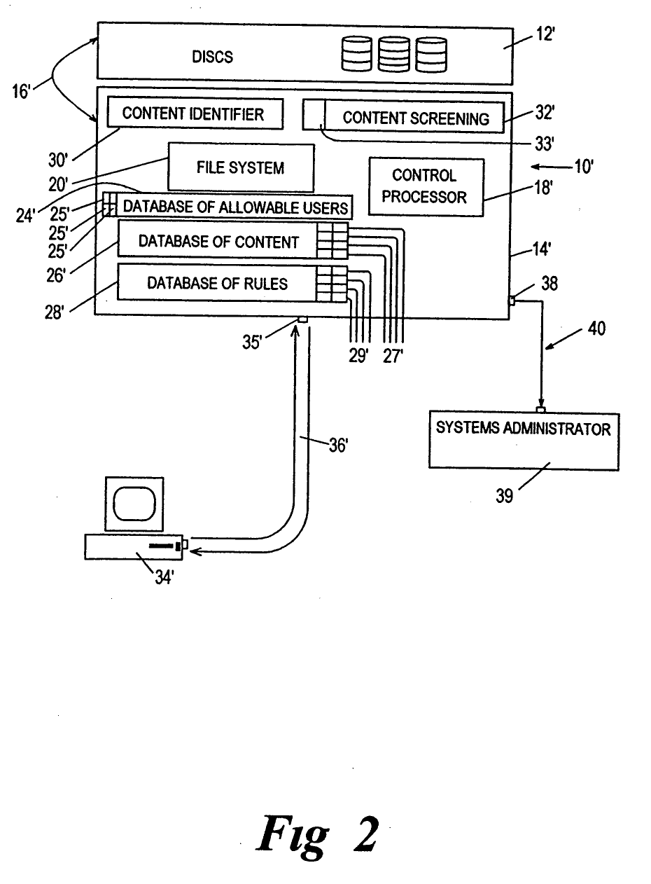

FIG. 2 shows a similar NASD 10′ similar to that of FIG. 1, with similar structures being given similar reference numerals, but with a prime. The NASD has a communication port 38 linking the NASD to a systems administrator 39, via a telecommunications link 40. The port 38 may be the port 35′, and the link 40 may be part of the network 36′.

The rules in the database of rules 28′ this time say that when an attempt to record prohibited content is detected by the device 10′ the control processor 18′ causes the generation of a signal or message indicative of this fact and cause the transmission of this signal to the systems administrator 39. This may happen on an ad-hoc basis in real time as and when attempts to store prohibited matter are detected. Additionally or alternatively a report of user ID's and their attempts to store prohibited matter may be generated and/or transmitted periodically. In one embodiment the data content entity with prohibited content is sent to the systems administrator 39 instead of being stored in memory 12′. The user 34′ may or may not receive a message from the device 10′, and/or the administrator 39, informing them that their attempt to store data content has been refused and the systems administrator has been informed.

A similar arrangement exists in the embodiments of FIGS. 1 and 2 in relation to attempts to read data content that is stored upon the device 10 or 10′ but for which access is prohibited for a particular user. The user may still be charged/a charge may still be generated and sent somewhere, and a systems administrator may or may not be informed, and the user may or may not be informed that an attempt to read a prohibited file has been detected.

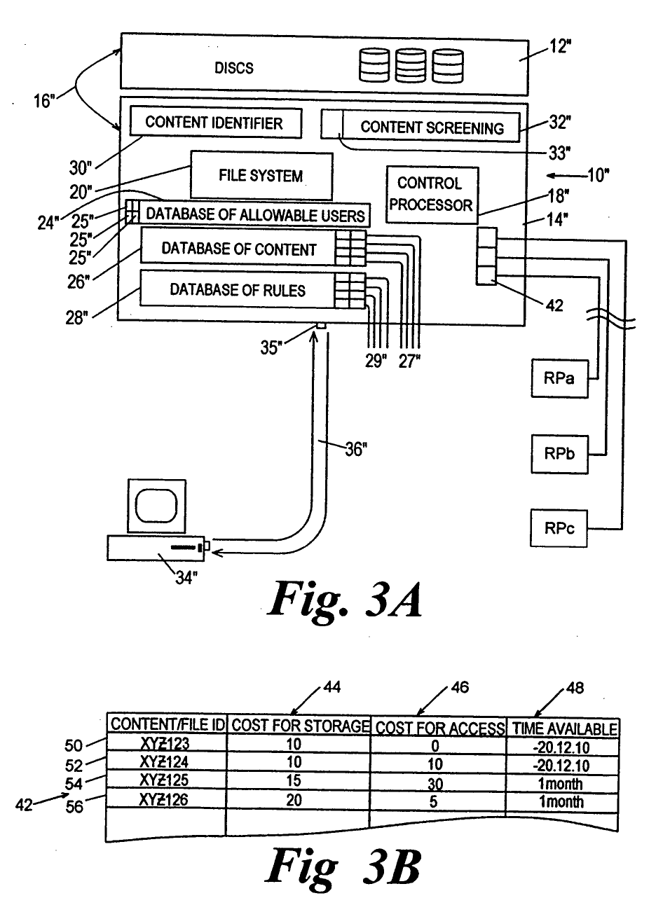

FIG. 3A shows another NASD, referenced 10″, that is similar to those of FIGS. 1 and 2. Similar structure has been given the same reference numerals as previously, but with a double prime. The device 10″ has a third party-controllable content-related parameter database 42 which contains in this example parameters 44, 46, 48 associated with files 50, 52, 54, 56.

A first rights provider, RPa, for the sake of example a publisher of chart music, has access to the device 10″ and is able to set and change parameters associated with data content over which they have rights. For example, if file 50, in this example having the identity XYZ123 (but it could be “Yellow Submarine” by The Beatles; or any content-specific identifier) has rights, e.g. copyrights, which belong to RPa or are controlled by RPa, then RPa is recognised by the processor 18″ as being authorised to set or change the values attributed to the parameters 44, 46, 48, for that data content entity, and for other content entities that they own or control. RPa may transmit a suitable identity or recognition code in order to be recognised as RPa.

The content-related parameters in this example are: parameter 44 is the cost to the host file server 10″ for permission to store the file 50 on its memory; parameter 46 is the cost required by the rights provider RPa from users seeking access to the file 50; and parameter 48 is the time for which the rights provider RPa agrees for the file to be available for access by permitted users. In this example, the cost for storage is 10 cents, the cost for accessing is nothing, and the time that the content provider agrees that the file is to be available is until 20 Dec. 2010.

The owner or controller of the device 10″ may have their own costs, which could also be parameters of the database 42. For example they could charge the person putting a data content entity onto their device 10″ a charge, for example to pass on the charge made by the Rights Provider, completely or partially covering the Rights Provider's storage charge. They could also charge a user seeking to read the file 50 their own charge additional to that of the Rights Provider.

In practice any charges are preferably billed in a single bill (in this example) and the device 10″, or an associated billing systems accounts to the Rights Provider(s).

In the example discussed the Rights Provider controlled parameters are input into a database on the NASD. In an alternative variant the NASD may look them up, possibly as and when it needs them, from a source external to the NASD. They may be stored on a server of a Rights Provider.

In the example of FIGS. 3A and 3B, a second Rights Provider RPb has rights in the data content of a second file 52 and the processor 18″ recognises that entity, RPb, as having the ability to set and modify the parameters 44, 46 and 48 that relate to file 52, and also to any other files for which RPb is the Rights Provider (or at least one of the parameters if there is more than one parameter for a particular file).

Similarly, a third Rights Provider RPc has control of the parameters relating to their data content (the content over which they have rights), and can set and modify parameters associated with their content.

FIG. 3A shows the database 42 schematically split into sections, one for each Rights Provider. The database need not really be partitioned: a concordance between identity of different Rights Providers and “their” files may exist instead.

FIG. 3A shows communication between the Rights Providers and the database through unspecified telecommunications ports. It will be appreciated that in practice the Rights Providers will probably communicate with the device over the network 36″, which could be the Internet, and via telecoms port 35″ (i.e. no need for a special dedicated port or permanent hard-wired link). Alternatively, or additionally, the Rights Provider may receive an update in any suitable way, for example on a removable storage medium which may, for example, be loaded upon the NASD (e.g. CDROM, DVD, floppy disc or the like).

Data content entity 54, or file 54, is in this example a newly released popular song or video. It has a relatively high storage cost and cost for access (the figures of 15 cents and 30 cents shown in FIG. 3B are purely illustrative and are not necessarily representative of what may really be charged in practice). The period for access is shown as being one month from when the file was first stored. This is to encourage people to listen to/view the file quickly, before it becomes unavailable.

In FIGS. 3A and 3B, there is no communication from the device 10″ back to the Rights Providers a, b and c (apart from indirectly there is an accounting for rights stored and accessed). Communication is one-way: inputting of parameters by the Rights Providers.

It will be appreciated that the evaluation of rules in conjunction with parameters allows for finer granularity in access and/or storage options for the device 10, 10′, or 10″. For example, there can be time-dependent pricing. The cost of access and/or storing something can be set to vary with the time of day, day of the week, time since or before an event, etc.

The cost of access and/or storing something can vary with the identity of the content in question. The cost of access and/or storage can vary with the identity of the user in question.

The cost can vary dependent upon a past history of access/storage of the file in question, or other files (for example a single storage payment may allow a set number of, e.g. ten, read access “visits” to the file for any entity in a sharing club). Possibly thereafter successive read events may attract individual charges to someone. Which charges, and to whom can be set by rules, for example at a constant level, decreasing level (cheaper the more it is used), or a rising level (more expensive the more accessed).

The ability to link a file with an allowable group of identified users and to control and/or monitor access to that file can be interesting to Rights Providers. It may help to enable them to see who is sharing access to rights-protected files. Unless there is some kind of copy protection there is still, of course, the possibility of a user copying a file onto their own machine and using and showing the copy without using the NASD.

It will be appreciated that the data content entity could be put onto the NASD initially by a user 34, or that a Rights Provider could transmit the content onto the device 10, 10′, or 10″.

Unless the device 10, 10′, or 10″ can identify a particular data content entity stored upon it by a user as being associated with a particular Rights Provider, the Rights Provider will not be able to be credited with any sums involved with the authorised use/storage of the content. Since this identification process is performed using fingerprints or signatures of rights-protected content it is in the Rights Owner's interests to ensure that the NASD has as comprehensive a library as possible of fingerprints/signatures relating to their protected content. The Rights Providers RPa, RPb, and RPc may be able to transmit fingerprints/signatures of their rights protected content to the NASD for inclusion in the database of content 26″. The controlling entity or owner of the NASD may charge Rights Providers for the inclusion of their fingerprints/signatures in the content-screening process. A Rights Owner may own a NASD 10″.

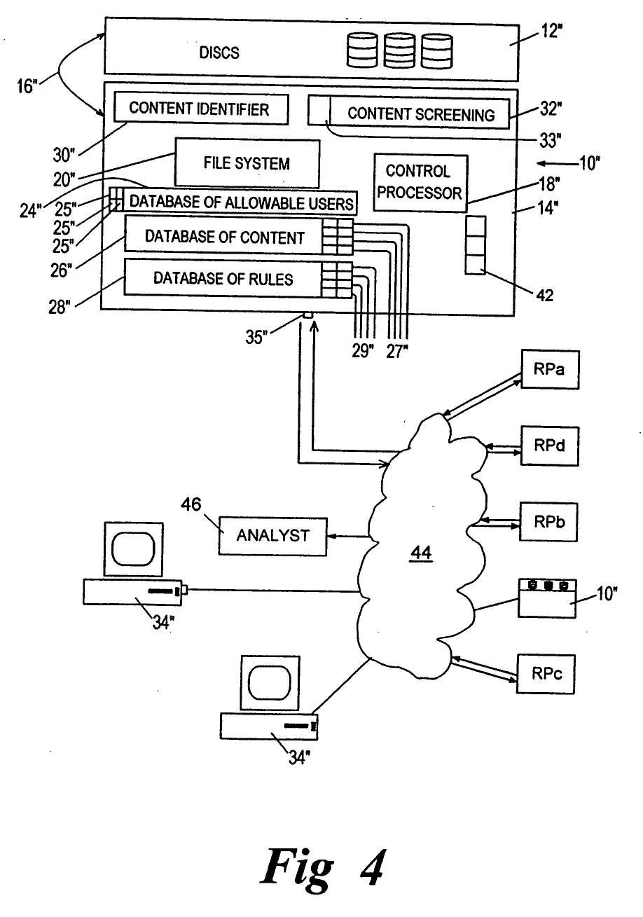

FIG. 4 shows the NASD 10″ of FIG. 3A as part of another network. In FIG. 3A the Rights Providers RPa, RPb, and RPc, and the user 34″ are shown connected to the NASD 10″ via Ethernet connectivity. In FIG. 4, the NASD 10″, the Rights Providers, and the user 34″ are connected via the Internet 44. Also shown is a further Rights Provider, RPd, and a further user 34″. There could of course be more users 34″ and more Rights Providers. FIG. 4 also shows another NASD 10″ networked via the Internet, and further NASDs could be included. FIG. 4 also shows an analyst 46 which receives information about the storage and read access transactions that take place between the users 34′ and the NASDs 10″.

As will be seen schematically in FIG. 4, the control processor 18″ has been configured to report back to the Rights Providers information on who is making requests to store their respective content (content recognised as being content over which they have rights). Each Rights Provider receives details of the use of their own content, but not details relating to other parties' content. However, in a variant one legal entity may be informed of transactions relating to content having rights owned by different legal entities. Information on what customers are doing with a competitor's rights-controlled content may be valuable. A Rights Provider may agree to pay for such information, and/or to pay for such information about activity relating to their own rights protected content; and/or agree to pay for the NASD not releasing data related to access activity relating to their rights protected content to third parties without their permission. Keeping ones own data content use data and patterns away from competitors may be valuable.

The processor 18″ can be configured to report content read access and/or content storage request information (probably without Rights. Provider input parameter information) to whatever parties the owner of the NASD wishes. In the embodiment of FIG. 4 an analyst 46 receives such data. The analyst entity then analyses the data and makes use of it. In one example the analyst comprises an accounts/billing function, possibly owned/controlled by the owner or controller of the NASD. The analyst generates periodic invoices for the users 34″ and e-mails the invoices to them periodically (say weekly, monthly, or quarterly).

In one embodiment the NASD itself has a billing analyst incorporated within itself and there is no need for account-generating information to go through the Internet or other computer network infrastructure in order for invoices to be produced and sent out.

Another form of analyst in another embodiment is a market research company. Each user 34 is categorised into one, or preferably a plurality of, demographic categories (e.g. geographical location, such as a city or a state, age, sex, income band, disposable income, educational background, etc.), and usage patterns can be established. Raw user-ID and associated data content storage/access activity may be sent by the device 10″ to the analyst 46, or the device 10″ may mask individual user ID's before transmitting information. For example, the device 10″ may have a database/flag/identifier associating each individual user with a demographic profile and the profile and associated usage history may be transmitted to the analyst. In an alternative embodiment, a market research analyst 46 is provided as part of the device 10″.

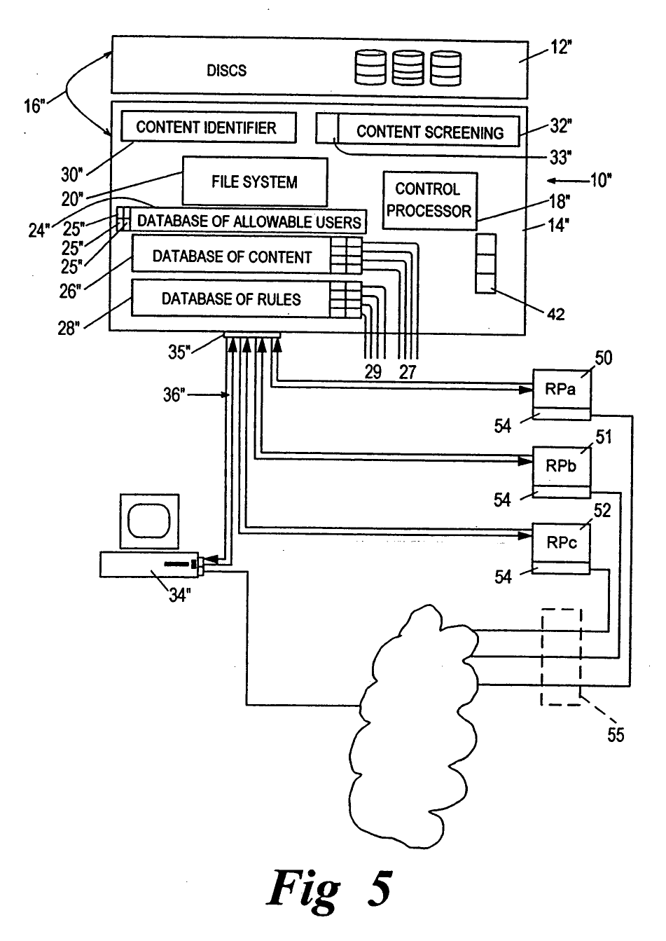

FIG. 5 shows the NASD 10″ as part of another network, which also includes the Rights Providers RPa, RPb and RPc. The Rights Providers are represented by computers 50, 51, 52, each of which has an associated billing program 54.

The NASD 10″ communicates with the computers 50, 51, and 52 via Ethernet connections, and they input content-related parameters via Ethernet connections. Data representation of a user and the use they have made (storing or reading) of a particular Rights Provider's works/content is sent to each Rights Provider's computer 50, 51, 52. Their billing programs 54 then generate their own invoices in respect of each user and/or the NASD 10″ and the invoices are transmitted from the computers 50,51,52. The invoices may go directly, e.g. via the Internet, to the user 34″ as shown, or they may be amalgamated into a combined invoice for each user. A bill constructor 55, shown in dotted outline, may be interposed between individual billing programs 54 and the user 34″. In a variant the billing programs reside on the NASD 12″, as may the bill constructor 55. If there are a plurality of NASDs that are network accessible to a user one of them may take the role of a bill master and may aggregate the invoices from the other NASDs and/or RPs, so that the user sees an aggregated bill, and possibly sees only one bill from networked NASDs and/or RPs.

Since the NASD 10″ is capable of reporting the identity of a user 34 to a Rights Provider when they make a request to store rights-protected content on the NASD, if they do so the Rights Provider has an opportunity to consider if they wish to take any action pursuant to that knowledge. For example, the Rights Provider may issue an invoice to the user 34 (as well as or instead of issuing an invoice to the owner of the NASD) in respect of the attempt (successful or not) to copy their protected work on the NASD. The Rights Provider may wish to contact a user 34 itself directly if the user is copying a rights-protected work to the NASD, but allow an intermediary (e.g. the NASD owner) to invoice them for read access activity. The person using a computer terminal/PC, or other network accessing device may not themselves receive an invoice, or themselves be personally charged. Instead another legal entity may be charged or invoiced, for example their employer, or other entity with which they are associated.

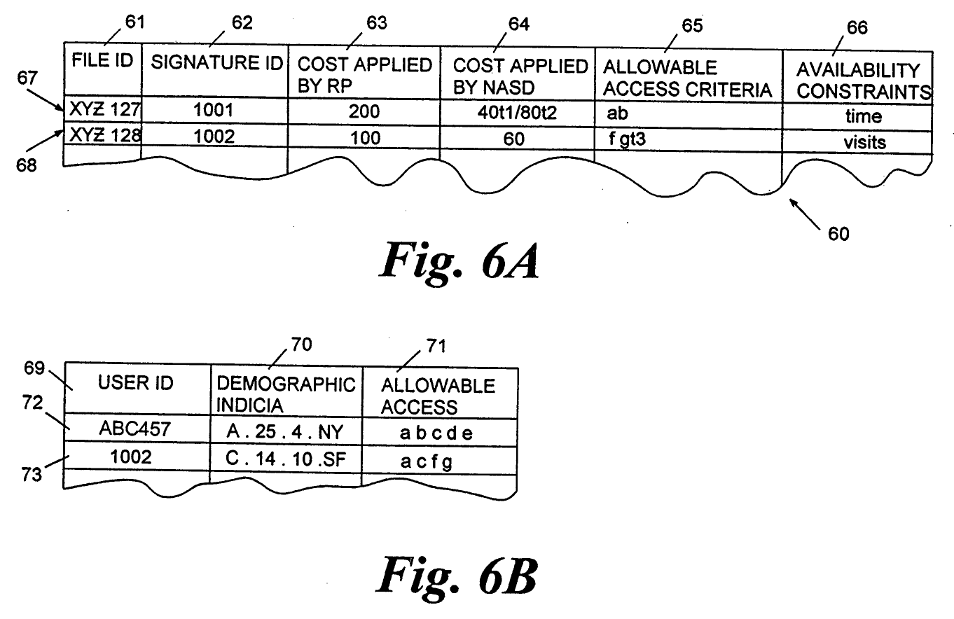

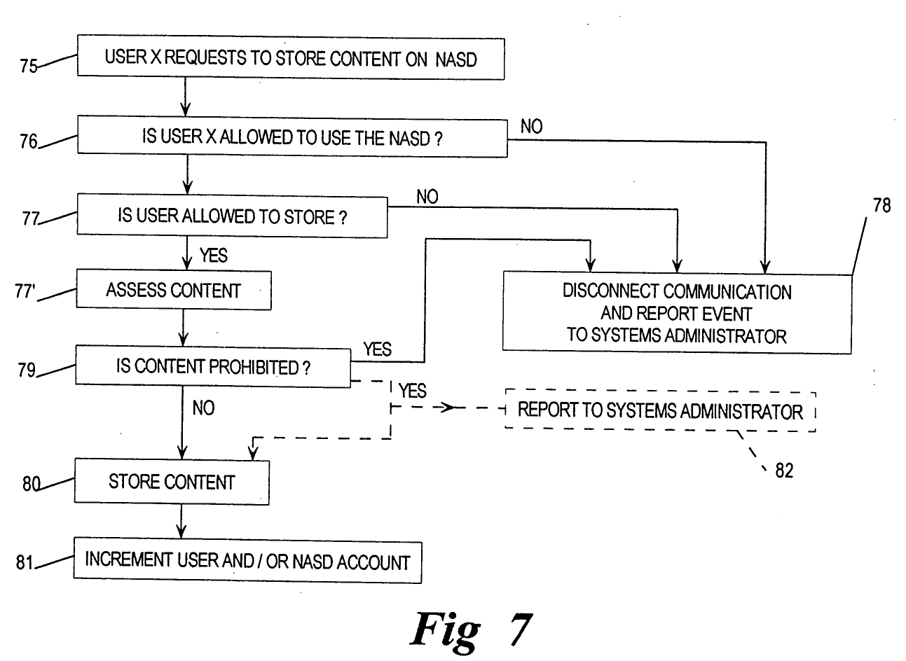

FIG. 6A shows a database 60 stored in, or accessible to, a NASD such as NASD 10, 10′, or 10″. The database 60 has a linking of content identities, or file identities 61, associated signature identities 62 (so that new content can be screened against the signatures); and associated content-related parameters. In this example the content related parameters are: cost to the user attributable to controlled by the Rights Provider 62, cost 63; cost attributable to/controlled by the NASD owner, cost 64; allowable access criteria 65 (what category of user can see/store what content); and availability constraints 66.

As shown in FIG. 6A, each file has its access limited to those users which match an access profile. In this example there are access categories a to g allocatable against each file, and allocatable to each user. A first file 67 is readable by users with access level a and b, and a second file, file 68, is readable by users with access level f. The availability constraints 66 for file 67 are time based: in this example reading of the file is permitted until a specified date. For file 68, the availability constraint is that only a permitted number of read accesses are to be given.

The allowable access criteria for file 68 is level f for all times, and level g during the times specified by a time t3 (e.g. can be accessed by level g authorisation so long as it is later in the day than a specified time). This illustrates the principle of time-dependent access criteria.

It will also be noted that the cost of accessing file 67 is time dependent: it has an element of “40”, e.g. 40 cents, at times t1, and an element of “80”, e.g. 80 cents, at times t2. This could allow for differential pricing at times of high network usage and/or differential pricing at times (e.g. days) spaced from a specified time (e.g. watching a sports event copyright work, for example a football game, may be more expensive if watched live, or nearly live, and less expensive—possibly progressively less expensive—if watched hours or days later.

FIG. 6B illustrates a database of user identities 69 correlated with user-related parameters 70 and 71. Parameter 70 is a demographic profile of a user, and parameter 71 is an allowable-access profile of a user. As shown in FIG. 6B, user 72 has a demographic profile that puts them in overall class “A”, with an income indicia of “25”, and a disposable income indicia of “4”, and in a geographic area of New York. User 73 has an overall demographic class of “C”, and income indicia of “14”, a disposable income indicia of “10”, and a geographic indicia of “SF”, identifying them as being in San Francisco.

User 72 can read files categorised as a, b, c, d, or e, but not f or g. They can therefore read file 67, but not file 68. User 73 can read files categorised as a, c, f or g, but not b, d, or e. They can therefore read file 68, but not file 67.

FIG. 7 shows a flowchart showing how software on the processor 18, 18′, or 18″ controls events.

At step 75 a user, user X, makes a request to store a particular data content entity on the NASD running the software. The software determines at step 76 whether the user is allowed access to the NASD at all, and if so proceeds to step 77 where the software assertains whether the user is permitted to store data on the NASD. If the user is not a permitted user (read or write) the software performs step 78, disconnecting the communicating link and reporting the unauthorised attempt to record content to a systems administrator. If the user is a permitted user and the user has authorisation to store data on the NASD the data content is assessed in step 77. If the user is determined in step 77 not to be permitted to store data on the NASD the user is disconnected in accordance with step 78.

The assessment step 77 includes a determination 79 of whether or not the content is prohibited. If during the assessment of the content of the data content entity it is determined by the software that the content is prohibited the processor carries out step 78, again disconnecting the link and reporting the event to a systems administrator. If the content is not prohibited the software proceeds to store the content, step 80, and increment a user and/or NASD account, step 81, possibly for future billing.

A variant is shown in dotted outline in FIG. 7. Instead of causing disconnection if there is an attempt to store prohibited content the software may allow the content to be stored (step 80), but report the event to a systems administrator (step 82).

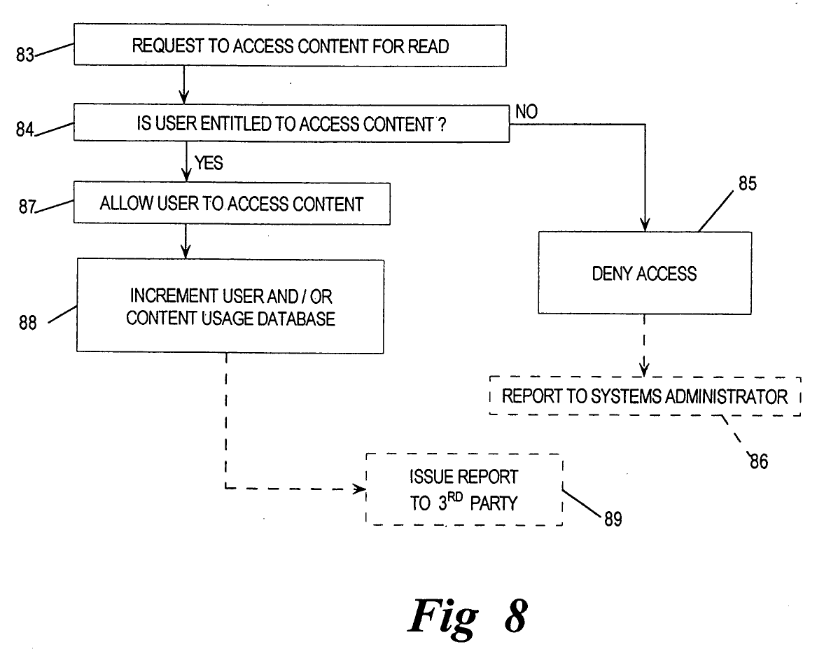

FIG. 8 schematically shows how software on a particular NASD embodiment responds to a request for access to a stored file. A request for access is received by the NASD, step 3. The software establishes whether the particular user making the request has authority to access the data content of a particular file requested, step 84, using the data content of the file itself, rather than the filename of the file. If they are not allowed to see the file data content access is denied, step 85, and optionally the attempt to view data content of a file for which they have no access authorisation may be reported to a systems administrator, step 86. If the user is allowed to receive the data content of that particular file they are allowed access to the content, step 87, and an account (financial or information/usage data) is modified, e.g. increased, relating to the user, and/or relating to the content, and/or the NASD, step 88.

FIG. 8 also illustrates, in dotted outline, the software possibly issuing a report to a third party, step 89. Such a report may be issued periodically, and may comprise billing and/or content-related usage data and/or user-related data.

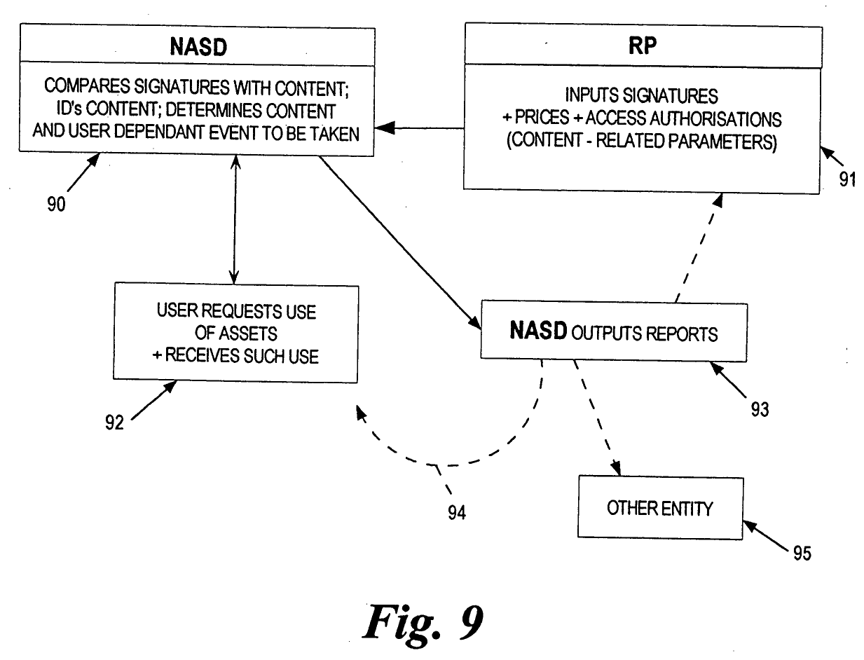

FIG. 9 shows a NASD 90, a Rights Provider 91, and a user 92.

The Rights Provider may also be a content provider, or they may not provide actual content. The Rights Provider 91 inputs to the NASD content-related parameters, such as prices for storing/accessing copyright works, and signatures/identifiers to enable copyright works to be identified by the NASD. A user requests access to read a file stored on the NASD 90, or requests that a file containing the copyright work be stored on the NASD 90. The NASD 90 compares the content of files that it is requested to store with the signatures input by the Rights Provider (or compares equivalent signatures) to try to identify the relevant Rights Provider. The NASD issues a report 93 including user-NASD interaction-related information. This report 93 could be an invoice 94 issued to the user 92, or a report issued to a third party that is not the user 92, or the NASD 90 (e.g. to the Rights Provider). The report may be issued to another entity 95 that is not in the group: NASD itself; user; Rights Provider for the file in question.

It will be appreciated that looked at in one way some embodiments of the invention may provide “object based” storage where storage devices have more intimate knowledge of the data they are storing and are capable of acting upon it in a more relevant way.

One particular embodiment may be utilised in corporate environments to ensure that large capacity NA-S devices (for example) are not utilised by staff to store undesirable content, or in the case of a storage device being utilised by a service provider hosting file sharing, it proffers a rights management way of billing based upon actual content.

The NAS servers described in many embodiments are essentially disc storage with a dedicated CPU and operating system designed to do one primary thing—serve files. In comparison with prior art NASDs, some embodiments of the invention have a database housed on the appliance which details a list of “disallowed” content—this is content that is not permitted to be stored. Disallowed content may be detailed in any known way, for example by identity data content as belonging to a disallowed class (e.g. too much skin colour in a picture, or not a text file, etc). This may be implemented using a simple filter (i.e. do not store any files that have the appropriate header for MP3/JPEG/GIF data etc.) or alternatively utilising a fingerprint or signature scheme that operates on the data content itself. A separate task may run under the operating system of the NASD, that task monitoring new files stored thereupon. Upon a file being created that is disallowed the appliance takes one of a plurality of predetermined actions. As indicated above, some possible actions include:

immediately removing the offending content (if configured so to do)—one could also flag items as administrator read-only; or

add the offending file to a list of newly created errant files that is sent to the administrator of the storage appliance, possibly on a regular basis; or

store the content and identify the content as worthy of further attention by a systems manager.

Furthermore, in order to perform the rights management scheme a similar rights management database is housed upon the storage appliance/device.

In one example, upon the creation of new files, creation is not disallowed but is looked up against a list of fingerprints for content (in many embodiments purposefully not against file name, which can easily be circumvented) and then a report is built up. The appliance then may take one of two actions:

(i) for the list of stored content for which fingerprints have been found (e.g. back catalogue of Island records)—connect to a rights management server and determine the cost of storing each piece of content and/or use thereof;

(ii) send the list of content to an administrator for further processing off storage appliance.

In connecting to a rights management server, one possible intent is that the content providers CP list a “micro-payment” cost which provides details for how the housing entity (storage device) is to be billed for merely housing that content, and how much for the use thereof. When the appliance/device is asked to read that file a bill is incremented in the database associated with that content. The rights management server may be centrally located and the storage device may interrogate it remotely. Another scheme would be to have the content marked per provider—e.g. Sony materials are looked up on a Sony rights management server.

Given a request to read content from the appliance, if rights management is enabled then the appliance may update the database bill for that content appropriately (this may be free e.g. pay once for the storage of a given data content entity, e.g. a Corbis JPEG, and then do as you will). Content may also be flagged as immutable—i.e. read/write requests to content may be disallowed if the content fingerprint matches an entity that is specified as “read-only” by the provider, but deletion requests may be allowed.

The above posits that the rights management if enabled on a storage appliance will “invisibly bill” the storer of content. In the case of content being removed from the device then the associated entity for billing in the device/appliance database may be removed. If there is a default on payment for rights, or non-payment for rights to use content, the appliance may disallow attempts to access data record entities by users that are in payment default.

A way of looking at some aspects of the invention is that the data storage device itself is content-aware: it knows what is at least some of the content upon itself, and it takes whatever has been programmed into it as being appropriate action depending upon that knowledge/identification.

The control processor is aware of some information relating to selected data content (the content itself) and takes an action using that knowledge. Previously data storage devices have not been “content-aware”: they have been dumb, and have not evaluated content stored on them/to be stored on them, nor have they changed behaviour based upon the type of content hosted upon themselves.

In many embodiments of the invention the storage of files is within a storage device used in a HTTP and web browser user environment, rather than within a LAN network file share environment. In many embodiments the data content analyser is part of the storage device: integrated storage device and data content analyser, with analysis of the data content taking place within the data storage device itself: a storage device with integrated content management is desirable in many embodiments.

In many embodiments putative content that is possibly to be stored in a storage device is stored first and then analysed (e.g. by computing a fingerprint or signature or hash) to determine whether or not to keep the content stored on the storage device. Embodiments which have possibly temporary storage of content whilst the content is being evaluated are considered advantageous in some circumstances. Many embodiments of storage device will use standard file sharing protocols (e.g. NFS/SMB) without modification. All of the content analysing intelligence may reside in the storage device itself.

1. A data storage device having a non-volatile memory for storing data content, and a control processor operable to evaluate selected said data content to establish whether there is a match between a characteristic of or a derivative of, said selected data content and a reference data content characteristic, or derivative, and to take an action in response to establishment of a said match.

2. A device according to claim 1 wherein said action includes sending information relating to an interaction between an accessing party and content accessed by said accessing party, said processor being adapted to send said information to a party that is not said accessing party.

3. A device according to claim 1 wherein said control processor is operable to perform at least one of:
(i) a sweep of data content stored in said memory in order to evaluate said content;
(ii) to perform an evaluation of content putatively to be added to said memory of the data storage device prior to said content being added to said memory.

4. A device according to claim 3 wherein said memory comprises file-serving memory and further including a content evaluating buffer memory for storing newly received content prior to or whilst newly received content is evaluated.

5. A device according to claim 3 wherein said memory comprises file-serving memory and further including a content evaluating buffer memory for storing newly received content prior to and whilst newly received content is evaluated.

6. A device according to claim 1 comprising a library of data content characteristics or derivatives.

7. A device according to claim 6 wherein said data content characteristics comprise an identity characteristic to identify said-data content as being known, and wherein said identity characteristic is from the group:
(i) a signature derived from said data content;
(ii) a fingerprint derived from said data content.

8. A device according to claim 1 comprising a data content-related parameter correlation, said correlation linking content-related parameters with equivalent known data content characteristics or derivatives, said processor being adapted to use said parameters for determining said action.

9. A device according to claim 8 wherein said parameters are controllable by a third party.

10. A device according to claim 1 wherein said processor is configured to enable third party mediated control of said action.

11. A method of operating a network attached storage device, the method comprising
upon receipt of a request to store content, attempting to identify the content to be stored, and following a set of rules to be followed if the data content is identified or is not identified as being known, and
undertaking appropriate action in response to the identification of the identity of said data content to be stored in accordance with said set of rules.

12. A method according to claim 11 wherein said content comprises a data content entity from the list: file; database.

13. A method according to claim 12 wherein:
(i) a specific identity of a data content entity is identified; or;
(ii) a group or class of data content to which a particular data content belongs is identified.

14. A method according to claim 12 comprising streaming data content from a file.

15. A method according to claim 14 comprising streaming rich media data content.

16. A method according to claim 11 wherein said attempt to identify content of a data content entity comprises producing a signature or fingerprint using said data content and comparing said produced signature or fingerprint with reference signatures or fingerprints relating to data content whose identity is already known.

17. A method according to claim 11 wherein said appropriate action comprises performing an action from the group:
(i) storing said content;
(ii) not storing said content;
(iii) communicating with a third party;
(iv) informing a third party that said data content has been stored, or that an attempt to store it was made.

18. A method according to claim 11 further comprising interacting between a party external to the device that is not a data content accessing party accessing data content and the device.

19. A method according to claim 18 wherein said interaction comprises the external party performing at least one of:
(i) providing information into said device;
(ii) receiving information from said device.

20. A method according to claim 11 wherein there is third party mediated control of said appropriate action undertaken by said device to user requests to store and/or access data content.

21. A method according to claim 11 wherein there is a communication to said device of at least one of:
(i) a data content entity signature or fingerprint from a third party;
(ii) a parameter which interacts with said rules to assist in controlling what is said appropriate action.

22. A method according to claim 21 wherein said parameter comprises a cost of read access or of write access for a particular data content.

23. A method according to claim 11 comprising said data storage device ascertaining an identity of a computer device which has made a request to perform at least one of (a) store data content and (b) read data content.

24. A method according to claim 23 comprising providing an identity of an accessing party to an external party and/or providing to an external party information derived from that identity.

25. A method according to claim 11 wherein said appropriate action comprises generating or augmenting an account related to a user identity and/or an identity of said storage device, and wherein said account comprises at least one of:
(i) a financial account for request for payment;
(ii) an information account for analysis.

26. A method according to claim 11 performed on a device which has content-usage control parameters corresponding to and associated with each identified content, the method comprising using said content-usage parameters in determining what appropriate action is undertaken.

27. A method according to claim 26 performed with a device for enabling a third party to input said content-usage parameters to said device, said method comprising the third party inputting said content-usage parameters to said device.

28. A method according to claim 27 wherein said third party inputs at least one of:
(i) a price to be charged associated with said content;
(ii) a price to be charged to said device or an owner of said device;
(iii) a price to be charged to a party requesting storage of said content, or to an entity associated with the requesting party;
(iv) a limitation upon the use of said content.

29. A method according to claim 26 wherein a content rights owner maintains content-usage parameters accessible by said device at a location that is at least one of:
(i) off-device;
(ii) on-device.

30. A method according to claim 11 wherein said device is operable to interact with a party external to said device and said appropriate action comprises at least one of:
(i) communicating with a party external to said storage device;
(ii) providing information to a third party external to said device that is not the person requesting content to be stored;
(iii) issuing a request for payment to a party;
(iv) providing content-storage or use-related information to a rights owner who is recorded on said storage device as owning rights in content that has been identified;
(v) providing content-storage or use information to a third party that is not the owner of the rights to which the information relates.

31. A network attachable file server having:
a computer memory for storing files;
a file content monitor processor;
a reference library for file content related signatures and content-related attributes correlated with said signatures;
said processor being operable to evaluate content of a file for determining a content related attribute of the file and for acting in response to the evaluation of the content related attribute of the file;
the processor being operable to perform the evaluation by performing steps including obtaining from the library a signature or fingerprint of said file and comparing said obtained signature or fingerprint with stored signatures or fingerprints of said reference library for establishing a match, and for thereby establishing a correlated content-related attribute of said file, said processor being adapted to take said predetermined action dependent upon what content-related attribute of said file has been established.

32. A server according to claim 31 wherein said content-related attribute comprises at least one of:
(i) a unique file identity;
(ii) an identity of a class or kind of data content of said file.

33. A network having at least one Network Attached Storage Device, NASD, said NASD being arranged for performing the method of claim 1.

34. A network having at least one Network Attached Storage Device, NASD, said NASD including the server of claim 31.

35. A method of integrating storage of data files having a data content with management of rights associated with said data files using a network attached file server which is capable of accessing said data content of a file and which is capable of producing a report relating to at least one of (a) storage and (b) access of files having associated rights, the method comprising using said file server to assess files stored on it, or files to be stored on it, to determine if an attribute related to the content of accessed files can be established by screening said content against known attributes, thus establishing said content as belonging to a known file or class of files, using the results of the assessment to produce said report.

36. The method of claim 35 further including transmitting said report externally of said file server.

37. A method according to claim 36 wherein said report comprises at least one of:
(i) a financial report used in the generation of an invoice;
(ii) market research information.

38. A machine readable data carrier storing a program which when run on a processor of a computer memory network attached storage device having a processor, a non-volatile memory, and a library of signatures or fingerprints, is adapted to cause said storage device to:
evaluate data content of a data content entity either stored in said memory or received by said device for storage in said memory and to create a signature or fingerprint derived from said data content and capable of identifying said data content;
and to compare said created signature or fingerprint with reference signatures or fingerprints held in said library of signatures or fingerprints for establishing whether said created signature or fingerprint matches a reference signature or fingerprint and for thereby establishing an identity of said data content; and
perform a predetermined act which is influenced by said identity of said data content.

39. The carrier according to claim 38 wherein said predetermined act includes communicating externally of said device information that is related to said identity of said data content.

40. The carrier according to claim 39 which causes said device to refer to a set of content-related parameters in determining what is to be said predetermined act.

41. The carrier according to claim 40 which is adapted to cause said device to permit said parameters to be input by signals sent to said device.

42. The carrier according to claim 40 which is adapted to cause said processor to permit one set of parameters to be associated with a group of data content entities controlled by a party external to said device, and a different set, or different sets, of parameters controllable by a different party external to said device, or further external parties.

43. The carrier according to claim 40 which is adapted to cause said processor to permit a specific data content entity to have a plurality of parameters relating to it, and to permit different parties to set different parameters of the same data content entity.

44. The carrier according to claim 41 which is adapted to cause said processor to enable third party mediated control of the response of the NASD to user requests to store or access data content entities.

45. A programmed memory storing a program which when run on a processor of a computer memory network attached storage device having a processor, a non-volatile memory, and a library of signatures or fingerprints, is adapted to cause said storage device to:
evaluate data content of a data content entity either stored in said memory or received by said device for storage in said memory and to create a signature or fingerprint derived from said data content and capable of identifying said data content;
and to compare said created signature or fingerprint with reference signatures or fingerprints held in said library of signatures or fingerprints for establishing whether said created signature or fingerprint matches a reference signature or fingerprint and for thereby establishing an identity of said data content; and
perform a predetermined act which is influenced by said identity of said data content.

46. The programmed memory according to claim 45 wherein said predetermined act includes communicating externally of said device information that is related to said identity of said data content.

47. The programmed memory according to claim 46 which causes said device to refer to a set of content-related parameters in determining what is to be said predetermined act.

48. The programmed memory according to claim 47 which is adapted to cause said device to permit said parameters to be input by signals sent to said device.

49. The programmed memory according to claim 47 which is adapted to cause said processor to permit one set of parameters to be associated with a group of data content entities controlled by a party external to said device, and a different set, or different sets, of parameters controllable by a different party external to said device, or further external parties.

50. The programmed memory according to claim 47 which is adapted to cause said processor to permit a specific data content entity to have a plurality of parameters relating to it, and to permit different parties to set different parameters of the same data content entity.

51. The programmed memory according to claim 48 which is adapted to cause said processor to enable third party mediated control of the response of the NASD to user requests to store or access data content entities.

52. A method of controlling access to a memory of a data storage unit, the method comprising using knowledge of content of data content entities stored in, or to be stored in, said memory and a knowledge of user identity, and acting dependent upon said knowledge of the content and the identity of the user, said act being causally connected with a communication to or from a third party different from the user.

53. A network comprising:
an attached storage device having a memory and having details of files accessible through said device, details of users entitled to access said device for at least one of read and write operations, and a set of rules specifying actions to be taken upon receipt of a request from allowable users to access files, said rules being dependent upon the identity of at least one of a user and content of the file concerned;
a network link for enabling said device to be connected to a third party on the network; and
a processor as part of said device configured to monitor access by users to files and to communicate with a network attached third party data that is user and/or file dependent and representative of user-data content access activity.

54. A device according to claim 1 further comprising a programmed set of rules for determining what is to be said action;
wherein said memory is adapted to store a plurality of data content entities having data content;
wherein content-related parameters are adapted to be available to said processor, said content-related parameters being associated with corresponding data content entities;
and wherein said set of rules is adapted to use those of said content-related parameters which relate to a selected data content entity for determining what is to be said consequential action when said selected data content is established as having a characteristic or derivative that matches a known characteristic or derivative.

55. A device according to claim 54 further including a telecommunications connector, and said processor is programmed for enabling a third party external of said device to set at least some of said content-related parameters.

56. A device according to claim 55 wherein said content-related parameters have an associated content-related parameter control authority and said processor is programmed to determine that said third party is authorised to control at least the, or those, of said content-related parameters that said third party sets prior to allowing said third party to set the parameter or parameters.

57. A device according to claim 54 further including a user-identity and wherein a data content entity access concordance is adapted to exist, said concordance being arranged for influencing which data record entities in said memory can be accessed by which users, said processor being programmed to use said user-identity and said data content entity access concordance for determining whether or not a user is granted access to a data content entity stored in said memory.

58. A device according to claim 44 further including a user identity for enabling said processor to identify a user who requests at least one of read and write access to said memory; and wherein said set of rules is adapted to use the user identity as a factor in determining what is to be said action.

59. A device according to claim 54 wherein said processor is arranged so (a) said characteristic of said selected data content is established as matching a known characteristic by processing said selected data content to produce a representative fingerprint or signature and (b) said representative fingerprint or signature is compared with a library of known fingerprints or signatures representative of known data content.

60. A method of providing at least one of read and write access to a data record entity stored in a computer readable memory of a network attachable data storage device having stored therein or accessible thereto:
(i) information correlating a plurality of data record entities stored in said memory and content-related characteristics adapted to identify an equivalent said data record entity; and
(ii) access authority parameters associated with said data record entities or said content-related characteristics; the method comprising:
accompanying requests by a user access authority for at least one of read and write access to data content entities, there being a relationship between user access authorities and access authority parameters to enable a user to access data record entities for which the user has authority for read and/or write access, evaluating a user's access authority indicia and an access authority parameter of a requested data content entity by using the network attachable storage device.

61. The method of claim 60 further including determining whether access is granted or not in response to the evaluating step.

62. A method according to claim 60 further including generating an invoice for accessing data content entities by using an assessment of the identity of said user and identities of data content entities accessed by said user.

63. A method of integrated storage of rights-controlled data content entities and billing for at least one of storage and use of said rights-controlled data content entities, said method comprising
(i) evaluating requests for at least one of storage and read requests for access to memory of said device by using a network attached storage device, and comparing identities of users making said requests with content-related indicators by using a network attached storage device, and
(ii) generating billing relating to user access request activity based upon user identity and content identity.

64. The method of claim 63, further including determining whether said requests are allowed.

65. A computer accessible data storage device comprising a data store and a processor,
said processor comprising reference data content characteristic means having or being adapted to obtain, reference data content characteristics representative of known data content, and content identifying means adapted to evaluate a selected data content against said reference characteristics from said reference characteristic means for determining whether a characteristic of said selected data content matches a said known data content characteristics;
and said processor being programmed to take a consequential action in response to said content identifying means establishing that a characteristic of said selected data content matches a known characteristic.

66. A Network Attached Storage Device having:
a machine readable computer memory for storing data content entities in the form of files having a data content that is the information content of the entity; and
a memory access controller having a control processor operable to evaluate selected said data content to establish whether there is a match between a content-identifier, indicia, fingerprint or signature of said selected data content and a reference content-identifier, indicia, fingerprint or signature;
said control processor being adapted to (a) cause a file received by said Device and requested to be stored in the Device to be stored in computer memory, (b) cause data content of said received file to be evaluated for determining whether said file should continue to be stored or not, and (c) cause said received file to be stored for access by users or not stored for access in response to evaluation of said received file data content.

67. A device according to claim 66 wherein http compatible functionality is supported by the processor.

68. A Network Attached Storage Device having:
a machine readable computer memory for storing data content entities in the form of files having a data content that is the information content of the entity; and
a memory access controller having a control processor operable to evaluate selected said data content to establish whether there is a match between a content-identifier, indicia, fingerprint or signature of said selected data content and a reference content-identifier, indicia, fingerprint or signature;
said control processor being adapted to (a) cause a file received by said Device and requested to be stored in the Device to be stored in computer memory, (b) cause data content of said received file to be evaluated to determine whether said file should continue to be stored or not, (c) cause said received file to be stored for access by users or not stored for access in response to evaluation of said received file data content, or (a′) monitor third party access to data content stored upon said device and to bill an appropriate entity for accessing said data content.

69. In combination, a non-volatile memory for storing data content, and a control processor operable to take an action in response to a positive comparison between evaluated selected data content of the memory and a reference data content thereof.
